(19) United States
(12) Patent Application Publication
(10) Pub. No.: US 2016/0196284 A1
(43) Pub. Date: Jul. 7, 2016

(54) MOBILE TERMINAL AND METHOD FOR SEARCHING FOR IMAGE

(71) Applicant: KYOCERA CORPORATION, Kyoto (JP)

(72) Inventor: Atsuhiko KANDA, Kanagawa (JP)

(73) Assignee: KYOCERA CORPORATION

(21) Appl. No.: 15/068,406

(22) Filed: Mar. 11, 2016

Related U.S. Application Data
(63) Continuation of application No. PCT/JP2014/073901, filed on Sep. 10, 2014.

(30) Foreign Application Priority Data
Sep. 13, 2013 (JP) 2013-190223

(51) Int. Cl. G06F 17/30; G06K 9/00; G06F 3/0488; H04N 5/232

(52) U.S. Cl. CPC G06F 17/30259; H04N 5/23293; G06K 9/00248; G06F 3/0488; G06K 9/00281

(57) ABSTRACT

A mobile phone includes a camera unit and the like including a lens and the like, and a preview image is displayed on a display when a camera function is executed. When a search mode is set during execution of the camera function, and a touch operation is performed by a user on the preview image, a relative positional relationship between subjects is detected by utilizing a focal length of the lens. An object image is extracted based on the detected relative positional relationship and a touch position of the touch operation. In this state, when a shutter key is operated, a search result using the object image is obtained. A search result pop-up including the search result is displayed on the display.

### CROSS-REFERENCE TO RELATED APPLICATION

The present application is a continuation based on PCT Application No. PCT/JP2014/073901 filed on Sep. 10, 2014, which claims the benefit of Japanese Application No. 2013-190223, filed on Sep. 13, 2013. PCT Application No. PCT/JP2014/073901 is entitled “Portable Terminal and Image Search Method”, and Japanese Application No. 2013-190223 is entitled “Mobile Terminal, Image Search Program and Method for Searching for Image”. The content of which are incorporated by reference herein in their entirety.

### FIELD

The present disclosure relates to a mobile terminal and a method for searching for an image, particularly to a mobile terminal having a camera unit and a method for searching for an image.

### BACKGROUND

In a conventional method for searching for an electronic file, when image data is displayed on a page of a document, a part of image data can be registered as a search condition for the image data. The registered part of image data is referred to as image component data. When the image component data is selected as a search condition, image data can be obtained as a search result.

### SUMMARY

One aspect of the present disclosure includes a camera unit, a display unit and at least one processor. The processor is configured to detect a relative positional relationship between subjects from an image obtained from the camera unit. The processor is configured to extract an object image from the image based on the relative positional relationship. The processor is configured to search for predetermined information based on the object image. The processor is configured to output a search result.

According to one aspect of the present disclosure, in a mobile terminal (10: a reference character illustrating a corresponding part in embodiments, and this similarly applies in the following paragraphs), a camera unit (50-54) can output an image. For example, when the image is obtained, a display unit (14) displays a preview image based on the obtained image. For example, when a user performs an operation of selecting a subject, a processor (30, S19) can detect a relative positional relationship between subjects from the image obtained from the camera unit. The processor (30, S23, S95, S97) can extract an object image from the obtained image based on the detected relative positional relationship so that, for example, a subject selected by a user is included. For example, based on the object image, the processor (30, S31) can search for predetermined information related to the object image. The processor (30, S63) outputs the search result to, for example, the display unit, and the search result is displayed on the display unit.

According to one aspect of the present disclosure, an object image can be suitably extracted by utilizing the relative positional relationship between subjects, so that a search accuracy of an image search can be improved.

Another aspect of the present disclosure is a method for searching for an image in a mobile terminal (10) having a camera unit (50-54), a display unit (14) and at least one processor (30). The method for searching for an image includes detecting (S19), extracting (S23, S95, S97), searching (S31), and outputting (S63). In the detecting, the processer of the mobile terminal detects a relative positional relationship between subjects from an image obtained from the camera unit. In the extracting, an object image is extracted from the image based on the relative positional relationship. In the searching, predetermined information is searched for based on the object image. In the outputting, a search result obtained by the searching is output.

Also in another aspect of the present disclosure, an object image can be suitably extracted by utilizing the relative positional relationship between subjects, so that the search accuracy of the image search can be improved.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is an outline view representing the external appearance of a mobile phone according to one embodiment of the present disclosure, where FIG. 1(A) represents the external appearance of a front side of the mobile phone, and FIG. 1(B) represents the external appearance of a back side of the mobile phone.

FIG. 2 is an illustrative view representing an electric configuration of the mobile phone shown in FIG. 1.

FIG. 3 is an illustrative view representing one example of a state where a preview image is displayed on the display shown in FIG. 1.

FIG. 4A is an illustrative view representing one example of procedures of performing AF processing in the preview image shown in FIG. 3, representing one example of a state where a touch operation is performed on the preview image.

FIG. 4B is an illustrative view representing one example of procedures of performing AF (Auto Focus) processing in the preview image shown in FIG. 3, representing one example in a state where a subject has been brought into focus by the AF processing.

FIG. 5 is an illustrative view representing one example of divided regions set in the preview image displayed on the display shown in FIG. 1.

FIG. 6 is an illustrative view representing one example of a relative positional relationship table stored in the RAM (Random Access Memory) shown in FIG. 2.

FIG. 7A is an illustrative view representing one example of an operation of switching to a search mode in the preview image displayed on the display shown in FIG. 1, representing one example of a state where a tap operation is performed on a search key.

FIG. 7B is an illustrative view representing one example of an operation of switching to a search mode in the preview image displayed on the display shown in FIG. 1, representing one example of a state where a mode has been switched to the search mode.

FIG. 8A is an illustrative view representing one example of a flow of processing of extracting a search object image from the preview image displayed on the display shown in FIG. 1, representing one example of a state where a tap operation is performed at any position.

FIG. 8B is an illustrative view representing one example of a flow of processing of extracting a search object image from the preview image displayed on the display shown in FIG. 1, representing one example of a state where a relative positional relationship is detected and the tapped subject has been brought into focus.

FIG. 8C is an illustrative view representing one example of a flow of processing of extracting a search object image from the preview image displayed on the display shown in FIG. 1, representing one example of a state where an extraction region has been set.

FIG. 9A is an illustrative view representing one example of an operation of performing an image search with a search object image displayed on the display shown in FIG. 1, representing one example of a touch operation for performing the image search.

FIG. 9B is an illustrative view representing one example of an operation of performing an image search with a search object image displayed on the display shown in FIG. 1, representing one example of a state where a search result is displayed.

FIG. 10 is an illustrative view representing one example of a state where a preview image of a search mode of another example is displayed on the display shown in FIG. 1.

FIG. 11 is an illustrative view representing one example of a memory map of the RAM shown in FIG. 2.

FIG. 12 is a flowchart representing one example of a part of camera function processing of the processor shown in FIG. 2.

FIG. 13 is a flowchart following FIG. 12, representing one example of another part of the camera function processing of the processor shown in FIG. 2.

FIG. 14 is a flowchart representing one example of the image search processing of the processor shown in FIG. 2.

FIG. 15A is an illustrative view representing another example of a flow of processing of extracting a search object image from a preview image displayed on the display shown in FIG. 1, representing one example of a state where a tap operation is performed at any position.

FIG. 15B is an illustrative view representing another example of a flow of processing of extracting a search object image from a preview image displayed on the display shown in FIG. 1, representing a state where a relative positional relationship is detected and the tapped subject has been brought into focus.

FIG. 15C is an illustrative view representing another example of a flow of processing of extracting a search object image from a preview image displayed on the display shown in FIG. 1, representing one example of a state where an extraction region has been set.

FIG. 15D is an illustrative view representing another example of a flow of processing of extracting a search object image from a preview image displayed on the display shown in FIG. 1, representing one example of a state where the search object image has been extracted from the extraction region.

FIG. 15E is an illustrative view representing another example of a flow of processing of extracting a search object image from a preview image displayed on the display shown in FIG. 1, representing one example of a state where the extracted search object image is displayed.

FIG. 16A is an illustrative view representing one example of an operation of changing a search object image in the preview image shown in FIG. 15E, representing one example of a touch operation for extracting another search object image.

FIG. 16B is an illustrative view representing one example of an operation of changing a search object image in the preview image shown in FIG. 15E, representing one example of a state where another search object image has been extracted.

FIG. 17A is an illustrative view representing one example of an operation of cancelling extraction of a search object image in the preview image shown in FIG. 15E, representing one example of a state where a touch operation is performed on the search object image.

FIG. 17B is an illustrative view representing one example of an operation of cancelling extraction of a search object image in the preview image shown in FIG. 15E, representing one example of a state where extraction of the search object image has been cancelled.

FIG. 18A is an illustrative view representing another one example of a flow of processing of extracting a search object image from the preview image displayed on the display shown in FIG. 1, representing one example of a state where a tap operation is performed on a person's face.

FIG. 18B is an illustrative view representing another one example of a flow of processing of extracting a search object image from the preview image displayed on the display shown in FIG. 1, representing one example of a state where the detected person's face has been extracted as a search object image and a touch operation for searching is performed.

FIG. 18C is an illustrative view representing another one example of a flow of processing of extracting a search object image from the preview image displayed on the display shown in FIG. 1, representing one example of a state where a search result is displayed.

FIG. 19A is an illustrative view representing one example of an operation of switching the search result shown in FIG. 18C to another search result, representing one example of a state where a touch operation is performed on a cursor.

FIG. 19B is an illustrative view representing one example of an operation of switching the search result shown in FIG. 18C to another search result, representing one example of a state where another search result is displayed.

FIG. 20 is a flowchart representing one example of a part of camera function processing of the processing shown in FIG. 2 according to a second embodiment.

### DETAILED DESCRIPTION

### First Embodiment

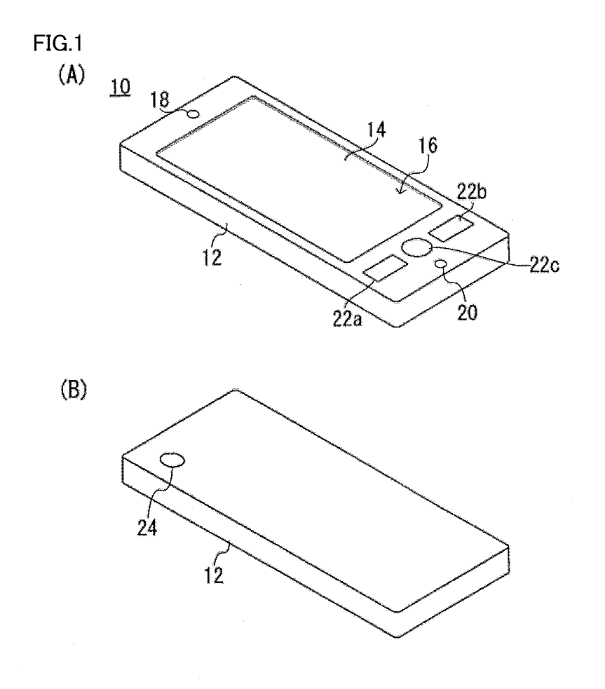

Referring to FIGS. 1(A) and 1(B), a mobile phone 10 according to one embodiment of the present disclosure is a smart phone as one example and includes a vertically long, flat rectangular housing 12. It is pointed out in advance that the present disclosure is applicable to any mobile terminals such as a digital camera, a tablet terminal, a tablet PC (Personal Computer), a note PC, a PDA (Personal Digital Assistant), and the like.

On a main surface (front surface) of housing 12, a display 14 is located, which is also referred to as a display unit, of liquid crystal, organic EL (Electro Luminescence), or the like. A touch panel 16 is located on display 14.

A speaker 18 is located on a main surface side at one end of housing 12 in a vertical direction, and a microphone 20 is located on the main surface side at the other end in the vertical direction.

In the first embodiment, a speech key 22a, an on-hook key 22b, and a menu key 22c are located on a main surface of housing 12 as hard keys constituting input operation means together with touch panel 16.

On the other surface (back surface) of housing 12, a lens opening 24 leading to lens 54 of the camera unit is located.

For example, a user can input telephone numbers by performing a touch operation on a dial pad displayed on display 14 by means of touch panel 16 and can start making a voice phone call by operating speech key 22a. When on-hook key 22b is operated, the voice phone call can be terminated. A user can turn on/off a power supply of mobile phone 10 by performing long press on on-hook key 22b.

When menu key 22c is operated, a home screen is displayed on display 14. A user can perform a touch operation on an object or the like displayed on display 14 by means of touch panel 16 in that state to select the object and settle the selection.

When a camera function is executed, a preview image (through image) corresponding to a subject field is displayed on display 14. A user can capture an image by directing the other surface located with lens opening 24 toward any subject and performing an image capturing operation.

Other than the telephone function, mobile phone 10 is capable of executing a mail function, a browser function, and the like. In the following description, a GUI (Graphical User Interface) including keys and the like, as well as icons, which are displayed on display 14, are sometimes collectively referred to as an object.

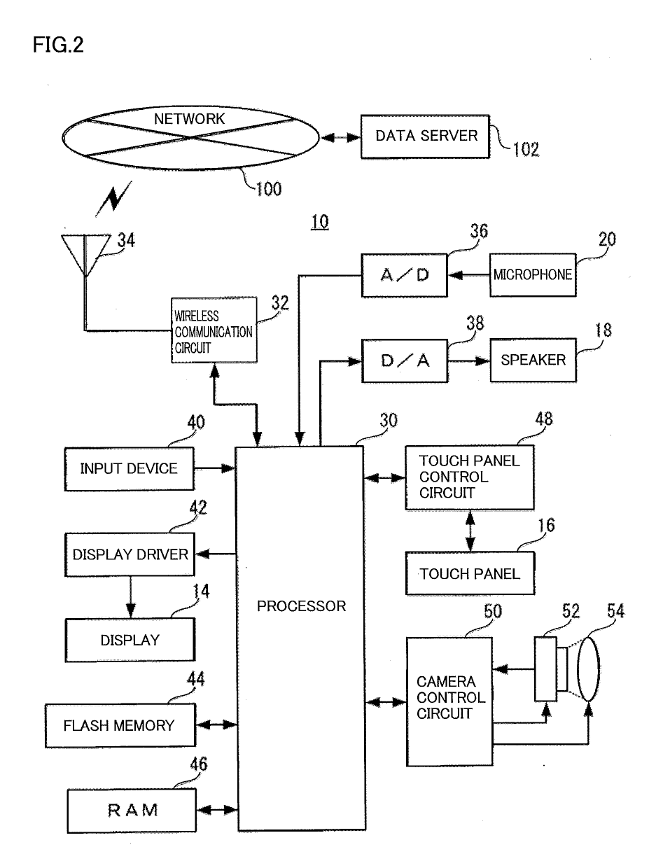

Referring to FIG. 2, mobile phone 10 of the first embodiment shown in FIG. 1 includes a processor 30 and the like which are referred to as a computer or a CPU (Central Processing Unit). Processor 30 is connected with a wireless communication circuit 32, an A/D (Analog to Digital) converter 36, a D/A (Digital to Analog) converter 38, an input device 40, a display driver 42, a flash memory 44, an RAM 46, a touch panel control circuit 48, a camera control circuit 50, and the like.

Processor 30 can manage an overall control of mobile phone 10. All or a part of a program pre-set in flash memory 44 is deployed on RAM 46 at the time of use, and processor 30 can operate in accordance with the program on RAM 46. RAM 46 is used as a working area or a buffer area for processor 30.

Input device 40 includes hard keys 22 shown in FIG. 1. Input device 40 constitutes an operation receiving unit for receiving a key operation by a user on hard keys 22. Information of hard keys (key data) operated by a user is input to processor 30.

Wireless communication circuit 32 is a circuit configured to transmit and receive radio waves for a voice phone call, a mail, or the like through an antenna 34. In the first embodiment, wireless communication circuit 32 is a circuit configured to perform a wireless communication by the CDMA (Code Division Multiple Access) method. For example, when a user operates touch panel 16 to instruct a call (voice calling), wireless communication circuit 32, under the instruction by processor 30, can execute voice calling processing and output a voice calling signal through antenna 34. The voice calling signal is transmitted to a telephone of a mate through a base station and a communication network. When voice call receiving processing is performed on the telephone of the mate, a communicable state is established, and processor 30 can execute the call processing.

Wireless communication circuit 32 is wirelessly connected to a network (e.g., communication network or telephone network) 100 through antenna 34. A data server 102 is connected to network 100 by wired or wireless connection. Mobile phone 10 can establish a communication with data server 102 through network 100.

Microphone 20 shown in FIG. 1 is connected to A/D converter 36. As described above, a sound signal from microphone 20 is converted by this A/D converter 36 into digital sound data and input to processor 30. Speaker 18 is connected to D/A converter 38. D/A converter 38 can convert digital sound data into a sound signal and give the same to speaker 18 through an amplifier. The sound based on the sound data is output from speaker 18. In a state where call processing is executed, sound collected by microphone 20 is transmitted to a telephone of the mate, and the sound collected at the telephone of the mate is output from speaker 18.

Processor 30 can adjust a volume of sound output from speaker by controlling an amplification factor of the amplifier connected to D/A converter 38 in response to, for example, a volume control operation performed by a user.

Display 14 shown in FIG. 1 is connected to a display driver 42. Display 14 can display a picture or an image in accordance with picture or image data output from processor 30. Display driver 42 includes a video memory temporarily storing image data to be displayed, and data output from processor 30 is stored in this video memory. Display driver 42 can display an image on display 14 in accordance with a content of the video memory. Under the instruction by processor 30, display driver 42 can control a display operation of display 14 connected to display driver 42. Processor 30 is sometimes referred to as a display control unit. A back light is located in display 14, and display driver 42 can control brightness and on/off of the back light in accordance with an instruction by processor 30.

Touch panel 16 is connected to touch panel control circuit 48. Touch panel control circuit 48 can give a required voltage to touch panel 16 and input a touch start signal indicating starting of a touch by a user on touch panel 16, an end signal indicating termination of the touch by the user, and coordinate data indicating a touch position of the touch by the user. Processor 30 can determine which object is touched by the user based on this coordinate data.

In the first embodiment, touch panel 16 is a touch panel of a capacitive sensing type configured to detect a change in the electrostatic capacity generated between the surface and an object such as a finger (hereinafter, it will be collectively referred to as a finger). Touch panel 16 can detect a contact of, for example, one or a plurality of fingers on touch panel 16. Touch panel 16 is also referred to as a pointing device. Touch panel control circuit 48 can detect the touch operation within a touch effective area of touch panel 16 and output coordinate data indicating the position of the touch operation to processor 30. A user can input an operation position, an operation direction, or the like to mobile phone 10 by performing a touch operation on the front surface of touch panel 16.

The touch operation of the first embodiment includes a tap operation, a long tap operation, a flick operation, a slide operation, and the like.

The tap operation is an operation of allowing a finger to be in contact (touch) with a front surface of touch panel 16 and thereafter allowing the finger to be apart (releasing) from the front surface of touch panel 16 within a short period of time. The long tap operation is an operation of allowing the finger to be in contact with the front surface of touch panel 16 for a predetermined time period or longer and thereafter allowing the finger to be apart from the front surface of touch panel 16. The flick operation is an operation of allowing a finger to be in contact with the surface of touch panel 16 and flicking the finger at a predetermined speed or higher in any direction. The slide operation is an operation of moving a finger in any direction while allowing the finger to be in contact with the front surface of touch panel 16 and thereafter allowing the finger to be apart from the front surface of touch panel 16.

The slide operation described above also includes so-called drag operation which is a slide operation of allowing a finger to be in contact with an object displayed on the front surface of display 14 and moving the object. An operation of allowing a finger to be apart from the front surface of touch panel 16 after the drag operation is referred to as a drop operation.

In the following description, the tap operation, the long tap operation, the flick operation, the slide operation, the drag operation, and the drop operation are some times described without the term “operation.” The touch operation is not limited to the operation by means of a user's finger and may also be performed by means of a stylus pen or the like.

An image sensor 52 and a motor (not shown) configured to adjust a lens position of lens 54 are connected to camera control circuit 50. Camera control circuit 50 is a circuit configured to take a still image or a moving image with mobile phone 10. For example, when an operation to execute the camera function is performed, processor 30 can activate camera control circuit 50 to execute the camera function. Camera control circuit 50, image sensor 52, and lens 54 are collectively referred to as a camera unit or an image capturing unit.

For example, an optical image of a subject is irradiated to image sensor 52. In an image capturing area of image sensor 52, a photodetector corresponding to, for example, SXGA (Super Extended Graphics Array: 1280×1024 pixels) is arranged. In the image capturing area, a raw image signal of SXGA indicating charges corresponding to an optical image of a subject is generated by photoelectric conversion. A user can change the size of image data to XGA (eXtended Graphics Array: 1024×768 pixels) and VGA (Video Graphics Array: 640×480 pixels) other than SXGA.

When the camera function is executed, processor 30 can activate an image sensor driver located in camera control circuit 50 and instruct the image sensor driver to perform an exposure operation and an operation to read out an electric charge corresponding to a specified read-out region of a subject, in order to display a preview image on display 14 which is a real-time moving image.

The image sensor driver executes exposure of an imaging surface of image sensor 52 and an operation to read out an electric charge generated by the exposure. Consequently, a raw image signal is output from image sensor 52. The output raw image signal is input to camera control circuit 50, and camera control circuit 50 performs processing, such as color separation, white balance adjustment, YUV conversion, and the like, on the input raw image signal to generate image data of a YUV format. The image data of the YUV format is input to processor 30.

Camera control circuit 50 calculates a focus evaluated value from the raw image signal and outputs the focus evaluated value to processor 30. Processor 30 can execute AF process based on the focus evaluated value output from camera control circuit 5. When the AF processing is executed, camera control circuit 50 can adjust a focal length f of lens 54 under the instruction by processor 30. A through image with a subject brought into focus is displayed on display 14.

The image data in the YUV format input to processor 30 is stored (temporarily stored) in RAM 46 by processor 30. The stored image data in the YUV format is converted by processor 30 into RGB data and thereafter given from RAM 46 to display driver 42. The image data in the RGB format is output to display 14. Accordingly, a low resolution (for example, 320×240 pixels) preview image representing a subject is displayed on display 14.

When an operation of capturing a still image is performed, processor 30 can execute main image capturing processing for a still image. Processor 30 can apply signal processing to a raw image signal of SXGA output from image sensor 52, store the same in RAM 46 once, and execute storage processing in flash memory 44. When the storage processing is executed, captured image data is read out from RAM 46 through processor 30. Processor 30 associates meta-information with the read-out captured image data and stores the same as one file in flash memory 44. Processor 30 can output, from a speaker not illustrated in the drawings, sound notifying that the main image capturing processing is not executed.

When a memory card is connected to mobile phone 10, the captured image data may be stored in the memory card. The meta-information associated with the captured image data is stored in the Exif (Exchangeable image file format).

When a user performs setting of capturing a moving image and performs the image capturing operation, processor 30 can execute the main image capturing processing for a moving image. Processor 30 can issue a command to camera control circuit 50 to output a raw image signal of VGA with a predetermined frame rate. Similarly to the main image capturing processing for a still image, processor 30 can apply a plurality of processing to each raw image signal read out at a predetermined frame rate and store moving image data in flash memory 44.

Address book data is stored in flash memory 44. Address book data and captured image data stored in flash memory 44 are sometimes collectively referred to as a database.

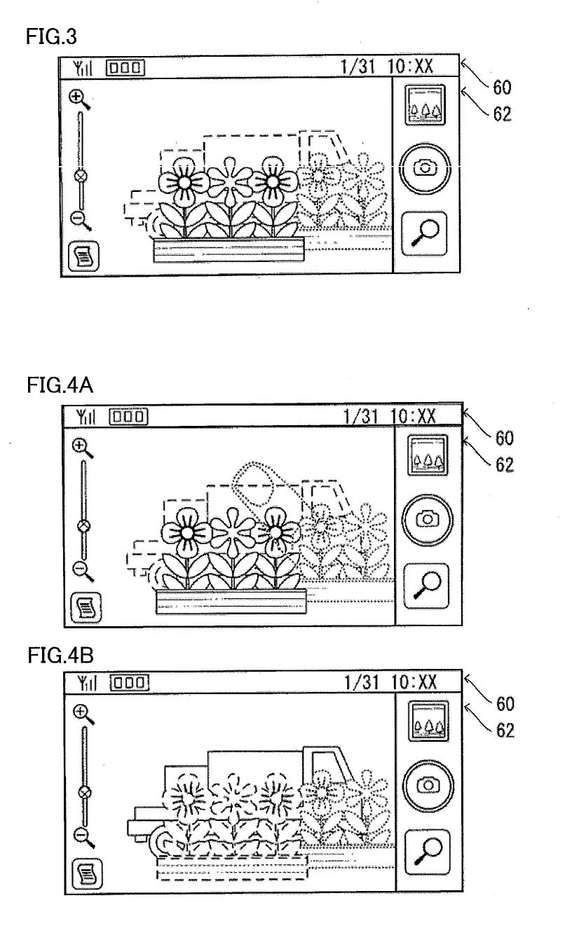

FIG. 3 is an illustrative view representing one example of a state where a preview image is displayed on display 14. A display area of display 14 includes a state display region 60 and a function display region 62. State display region 60 displays a pictogram indicating a radio wave receiving state of antenna 34, a pictogram indicating a remaining battery capacity of a rechargeable battery, and time. Function display region 62 displays a camera screen. In the camera screen, a preview image based on an output of the camera unit is displayed. A zoom slider and menu keys are displayed on the right side of the camera screen. A shutter key, a browse key, and a search key are displayed on the right side of the camera screen.

When the slide operation is performed on the zoom slider, an angle of view is changed by digital zoom processing or optical zoom processing.

When the tap operation is performed on the menu key, a GUI for changing settings of a white balance, an exposure correction, and the like is displayed. When the tap operation is performed on the shutter key, the main image capturing processing described above is executed. When the tap operation is performed on the browse key, a browse function enabling browsing of the captured image data stored in flash memory 44 is executed. When the touch operation is performed on the search key, a search mode is set. The search mode will be described later.

When the tap operation is performed at any position in the preview image, the AF processing is executed so as to bring the tapped subject into focus. For example, FIG. 3 shows a state where a flower bed on a front side is brought into focus. However, as shown in FIG. 4A, when the automobile on the back side is tapped, the AF processing of bringing the automobile into focus is executed. As shown in FIG. 4B, display 14 displays a preview image of a state where the automobile is brought into focus.

In the first embodiment, when the main image capturing processing is executed, processor 30 can detect a relative positional relationship between subjects and store the detected relative positional relationship as meta-information.

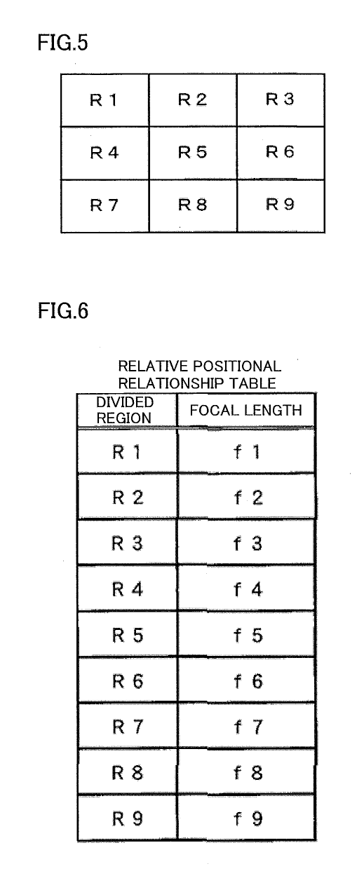

Specifically, referring to FIG. 5, nine divided regions R1-R9 are set in the preview image. When the shutter key is operated, focal length f of lens 54 is changed from a wide end to a tele end, and respective focus evaluated values of divided regions R during the change in focal length f are calculated. Focal lengths f with maximum focus evaluated values are specified respectively, and specified focal lengths f1-f9 are associated with divided regions R1-R9 respectively, and they are stored in the relative positional relationship table shown in FIG. 6. The relative positional relationship table storing focal lengths f1-f9 in such a manner is stored as a part of meta information of captured image data.

For example, when relative positions between subjects differ, focal lengths f corresponding to divided regions R including respective subjects differ. When the relative positions between the subjects are the same, focal lengths f corresponding to divided regions R including respective subjects have substantially the same value. When focal length f5 of divided region R5 and focal length f6 of divided region R6 are compared, and they differ, it is assumed that a subject included in divided region R5 and a subject included in divided region R6 are present at different positions (distances) from mobile phone 10. When focal lengths f of two divided regions R are substantially equal, it can be seen that the subjects included in respective divided regions R are present at substantially equal position (distance) from mobile phone 10. By storing focal lengths f with maximum focus evaluated values for a plurality of divided regions R, processor 30 can detect the relative positional relationship between the subjects. Since the relative positional relationship can be detected with use of focal length f of lens 54, the relative positional relationship between subjects can be detected even with an existing mobile terminal including a camera unit by updating or adding software.

In the first embodiment, the range of determining focal lengths f as having substantially equal value is 0.0-0.2 mm. In another embodiment, the range may be set narrower or wider than the range described above.

The number of divided regions R is set as nine in the first embodiment. However, the number may be greater or less in another embodiment. The size of divided regions R may be equal, or it may have different sizes in all or a part of divided regions R.

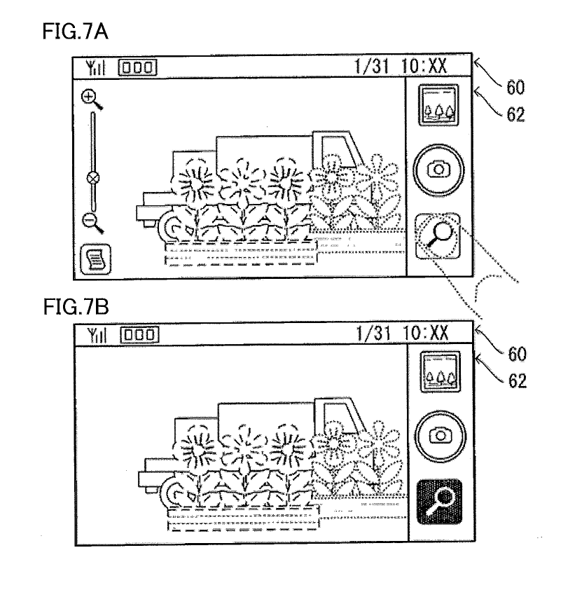

The search mode will be described. Referring to FIGS. 7A and 7B, as described above, when the tap operation is performed on the search key, the mode is shifted to the search mode. In the search mode, the color of the search key is inverted, and the zoom slider and the menu keys disappear. In the search mode, an image search is performed to obtain a search result of an image for a search from the database stored in data server 102 or flash memory 44 utilizing an image. When the tap operation is performed on the search key in the search mode, the mode returns to the image capturing mode. Algorithm and the like for the image search is a widely general art, thus it will not be described in detail.

In a method for searching for an electronic file, image component data must be registered in advance to search for image data. Moreover, when searching for image data, desired data must be selected from the registered image component data, thus such operation is likely to be time-consuming.

In the present disclosure, a search object image is suitably extracted by utilizing a relative positional relationship between subjects. A user can readily perform an image search.

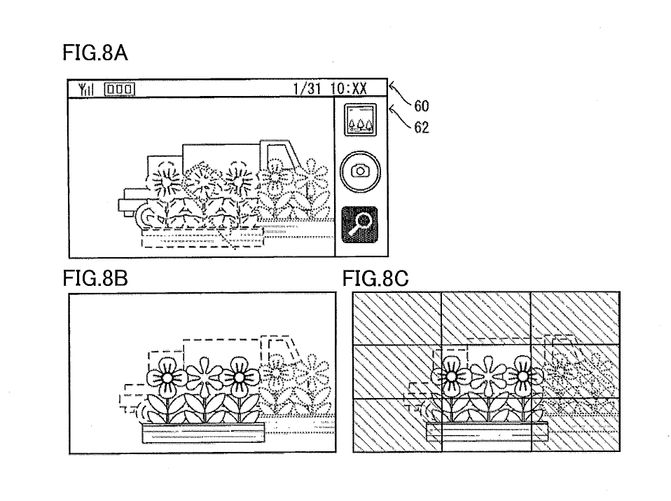

Referring to FIGS. 8A to 8C, for example, when the tap operation is performed at a position indicating the subject in the preview image, focal length f for each divided region R is stored in the relative positional relationship table, and the AF processing is executed based on the touch position. Based on the relative positional relationship table storing focal lengths f, divided region R including a subject which is present at a position substantially the same as the subject included in tapped divided region R is specified. Divided region R associated with focal length f having substantially the same value as focal length f of tapped divided region R is specified. For example, when focal lengths f of divided regions R5 and divided region R8 are substantially equal, and the tap operation is performed on divided region R5, divided region R8 is specified together with divided region R5. Divided region R5 and divided regions R8 are set as one extraction region, and an image within the extraction region is extracted as a search object image. When the search object image is extracted, a color of the preview image other than the extraction region is changed to a gray scale. By setting the extraction region, a user can understand a search object image to be extracted.

When the tap operation is performed on the extraction region, extraction of the search object image is cancelled. When the tap operation is performed at a position other than the extraction region, the search object image is changed. When the tap operation is performed at a position other than the extraction region, extraction of a search object image which has already been extracted is cancelled, and an image within the extraction region to which the tap operation is performed is extracted as a new search object image. According to the first embodiment, a user can change a search object even if he/she selects the search object by mistake.

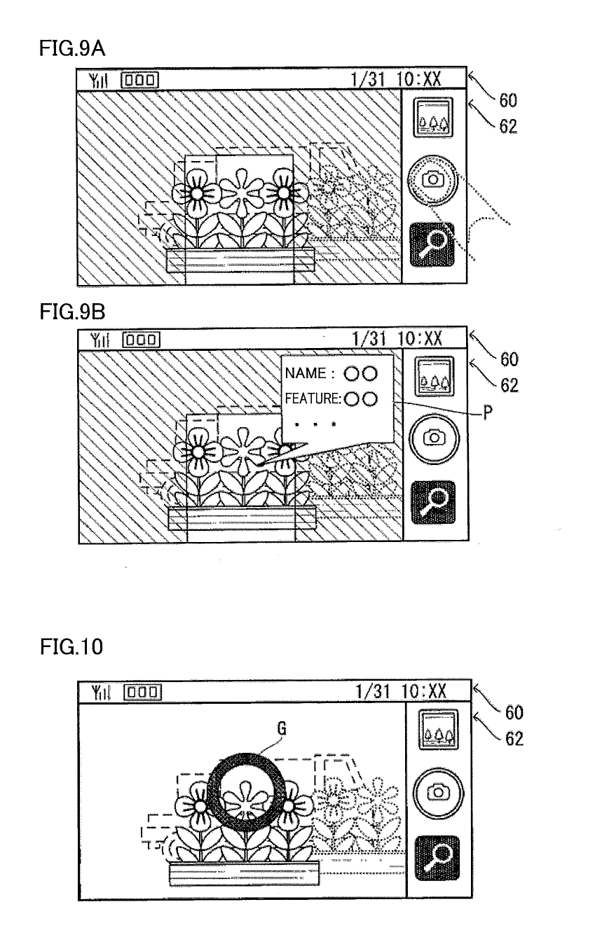

Referring to FIG. 9A, when the shutter key is operated in the state where a search object image is extracted, image search processing is executed to obtain a search result by means of the search object image. Specifically, databases stored in data server 102 and flash memory 44 are searched for information related to the search object image. For example, a flower is included as a subject in the search object image herein, and information such as the name and features of the flower is obtained as a search result from the database of data server 102. As shown in FIG. 9B, a search result pop-up P including the obtained search result is displayed while being associated with the search object image.

While texts are displayed in search result pop-up P shown in FIG. 9B, when an image is obtained as a search result, the image is also displayed in search result pop-up P. When the double-tap operation is performed on search result pop-up P, an obtained search result is enlarged and displayed in function display region 62. When the tap operation is performed outside of search result pop-up P, the search result is erased, and the setting of the extraction region is cancelled, and it returns to the state shown in FIG. 7B where a search object can be selected optionally. When a plurality of search results are obtained, the search result displayed in the search result pop-up is switched by a switching operation.

In the first embodiment, a search object image can be suitably extracted by utilizing the relative positional relationship between subjects. The search accuracy of the image search can be improved. A user can perform an image search for a subject of interest during image capturing. Particularly, a user can readily perform an image search by specifying a search object with an intuitive operation on touch panel 16.

A search object image being displayed is not rectangular in many cases. When performing the image search, it would be necessary that an image to be utilized for the search is rectangular. In the first embodiment, when a search object image is extracted, it is processed to be capable of conducting an image search by defining a rectangle having a minimum area to surround the search object image and pasting the search object image in the rectangle. In such a processed search object image, a portion having no original search object image depicted is colored with a predetermined color (such as white) or rendered transparent and colorless.

In another embodiment, a search object image may be extracted not by extraction of a search object image through the touch operation but by a guide ring G displayed on the camera screen. For example, referring to FIG. 10, in the search mode of another embodiment, guide ring G is displayed on the camera screen. If a user operates the shutter key after adjusting a position of mobile phone 10 such that a search object is located within guide ring G, the search object image is extracted based on the position of guide ring G. When the shutter key is operated in the state of FIG. 10, similarly to the case where a flower included in divided regions R5 is touched, the relative positional relationship between subjects is detected, and the extraction region is set. A search object image is extracted from the extraction region, and the image search processing is executed. In the state where guide ring G is displayed, a user can extract a search object image without performing the touch operation. When the shutter key is not a software key but a hardware key, the image search can be performed without using touch panel 16. The first embodiment can be applied to even a mobile terminal such as a digital camera having no touch panel 16.

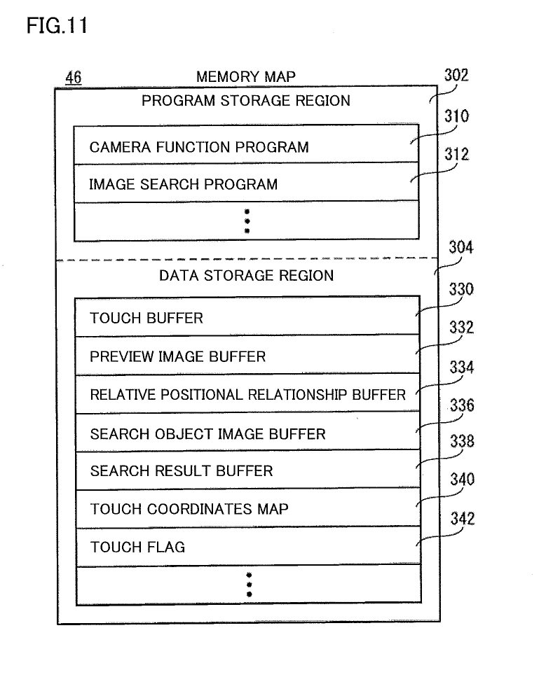

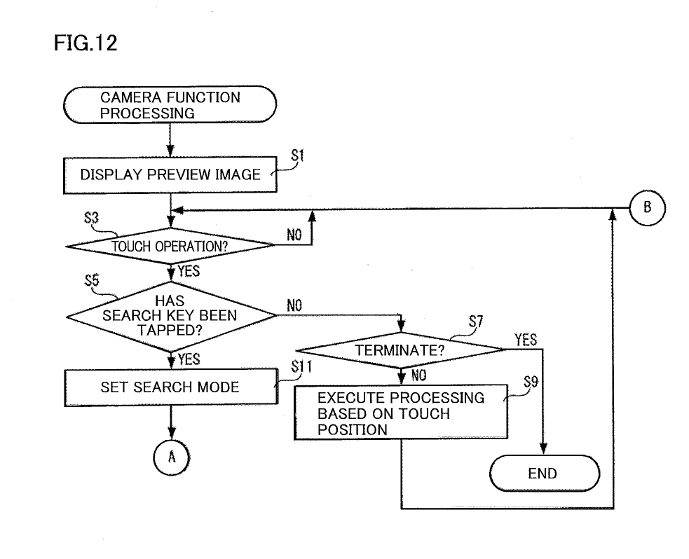

In the description above, features of the first embodiment are outlined. In the following paragraphs, detailed description is made with use of the memory map shown in FIG. 11 and the flowcharts shown in FIGS. 12 to 14.

Referring to FIG. 11, a program storage region 302 and a data storage region 304 are formed in RAM 46. As previously described, program storage region 302 includes a region for reading out a part or all of program data stored in advance in flash memory 44 (FIG. 2) and storing (deploying) the same.

Program storage region 302 stores a camera function program 310 for executing a camera function and an image search program 312 for performing an image search. Program storage region 302 also stores programs for executing functions such as a mail function, a browser function, and the like.

In data storage region 304 of RAM 46, there are located a touch buffer 330, a preview image buffer 332, a relative positional relationship buffer 334, a search object image buffer 336, a search result buffer 338, and the like. In data storage region 304, a touch coordinates map 340 is stored, and a touch flag 342 is also located.

Touch buffer 330 temporarily stores data of touch coordinates output by touch panel control circuit 48, data of touch coordinates at a starting point and an end point of the touch operation, and the like. Preview image buffer 332 temporarily stores an image output from the camera unit. When the camera function is executed, a preview image is displayed based on an image stored in preview image buffer 332. Relative positional relationship buffer 334 temporarily stores the relative positional relationship table when the relative positional relationship is detected. Search object image buffer 336 temporarily stores an extracted search object image. Search result buffer 338 temporarily stores a result of a search with a search object image.

Touch coordinates map 340 includes data for associating touch coordinates of the touch operation with display coordinates of display 14. A result of the touch operation performed on touch panel 16 is reflected on display 14 based on touch coordinates map 340.

Touch flag 342 includes a flag for determining whether or not touch panel 16 has been touched. For example, touch flag 342 includes a 1-bit register. When touch flag 342 is turned on (established), a data value “1” is set in the register. When touch flag 342 is turned off (not established), a data value “0” is set in the register. Touch flag 342 is switched on/off based on an output of touch panel control circuit 48.

In data storage region 304, data for displaying an object such as a GUI, and another flag or timer (counter) necessary for execution of the programs is located.

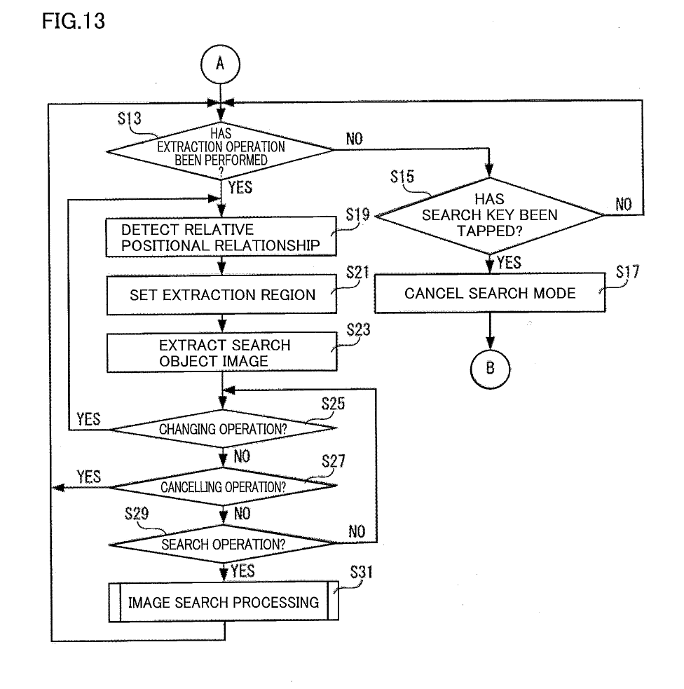

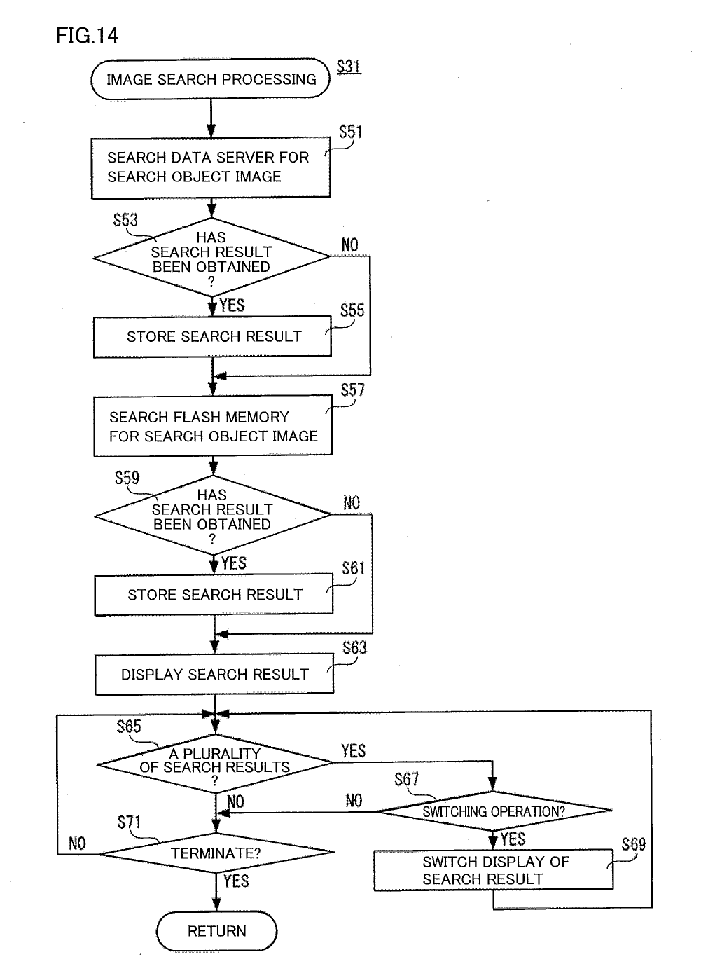

Under the control by Windows (registered trademark)-based OS (Operating System), Linux (registered trademark)-based OS such as Android (registered trademark) and iOS (registered trademark), and other OS, processor 30 can process in parallel a plurality of tasks including camera function processing shown in FIGS. 12 and 13 and image search processing shown in FIG. 14.

FIG. 12 is a part of a flowchart of the camera function processing. The camera function processing is started, for example, when the operation of executing the camera function is performed. In step Si, processor 30 can display a preview image. For example, processor 30 allows camera control circuit 50 be operated to read out a preview image based on an output of camera control circuit 50 from preview image buffer 332. The read-out preview image is displayed on display 14.

In step S3, processor 30 can determine whether or not the touch operation has been performed. It is determined whether or not touch flag 342 is in the on-state. When the touch operation has not been performed (“NO” in step S3), processor 30 can repeat the processing of step S3. When it is “YES” in step S3, for example, when the tap operation has been performed by a user, processor 30 can determine in step S5 whether or not the search key has been tapped; It is determined whether or not the touch operation for setting the search mode has been performed.

When the touch operation has not been performed on the search key (“NO” in step S5), processor 30 can determine in step S7 whether or not it is to be terminated. It is determined whether or not the touch operation for terminating the camera function has been performed. When the touch operation for terminating the camera function has been performed (“YES” in step S7), processor 30 can terminate the camera function processing. When the touch operation for terminating the camera function has not been performed (“NO” in step S7), processor 30 can execute in step S9 the processing based on the touch position. For example, when the touch operation has been performed at any position in the preview image, the AF processing is executed. When the tap operation has been performed on the shutter key, the main image capturing processing is executed. When the processing of step S9 is terminated, processor 30 can return to processing of step S3.

When the search key has been tapped (“YES” in step S5), the search mode is set in step S11. For example, when the search mode is set, the camera screen shown in FIG. 7 is displayed.

In step S13, processor 30 can determine whether or not an extraction operation has been performed. For example, it is determined whether or not the tap operation on the preview image as the extraction operation has been received. Processor 30 executing the processing of step S13 serves as a first reception unit. When the extraction operation has not been performed (“NO” in step S13), processor 30 can determine in step S15 whether or not the search key has been tapped. It is determined whether or not the operation of shifting to the image capturing mode has been performed. When the search key has been tapped (“YES” in step S15), processor 30 can cancel the search mode in step S17. For example, the camera screen shown in FIG. 3 is displayed again. When the processing of step S17 is terminated, processor 30 can return to the processing of step S3.

When the search key has not been tapped (“NO” in step S15), processor 30 can return to the processing of step S13. When the extraction operation of tapping the preview image has been performed (“YES” in step S13), processor 30 can detect in step S19 the relative positional relationship. Processor 30 can give a command of driving lens 54 to the camera unit (camera control circuit 50) and store focal length f with a maximum focus evaluated value in each divided region R in the relative positional relationship table. When the relative positional relationship table is stored in relative positional relationship buffer 334, the camera unit can move lens 54 such that a focus evaluated value of touched divided region R becomes maximum. The AF processing is executed with use of the result of detecting the relative positional relationship. In step S21, processor 30 can set the extraction region. Processor 30 can specify divided region R to which focal length f substantially equal to that of touched divided region R based on the relative positional relationship table and set specified divided region R as the extraction region. In step S23, processor 30 can extract a search object image. Processor 30 can extract image data of an image included in the set extraction region and store the extracted image data in search object image buffer 336. When the search object image is extracted, a color of the preview image other than the extraction region is set to be a gray scale. Processor 30 executing the processing of step S19 can serve as a detection unit. Processor 30 executing the processing of step S21 can serve as a setting unit. Processor 30 executing the processing of step S23 can serve as an extraction unit.

In step S25, processor 30 can determine whether or not it is a changing operation. It is determined whether or not the tap operation on the preview image other than the extraction region has been received. When the changing operation has been performed (“YES” in step S25), processor 30 can return to the processing of step S 19. When the changing operation has not been performed (“NO” in step S25), processor 30 can determine in step S27 whether or not it is a cancelling operation. Processor 30 can determine whether or not the tap operation on the extraction region has been received. When the cancelling operation has been performed (“YES” in step S27), processor 30 can return to the processing of step S13. When the cancelling operation has not been performed (“NO” in step S27), processor 30 can determine in step S29 whether or not it is a search operation. It is determined whether or not the tap operation on the shutter key has been received. When the search operation has not been performed (“NO” in step S29), processor 30 can return to the processing of step S25. When the search operation has been performed (“YES” in step S29), processor 30 can execute in step S31 the image search processing. Details of this image search processing will be described later. When the processing in step S31 is terminated, processor 30 can return to the processing of step S13. Processor 30 executing the processing of step S25 can serve as a second reception unit, and processor 30 executing the processing of step S31 can serve as a search unit.

FIG. 14 is a flowchart representing the image search processing. For example, when the processing of step S31 is executed, the image search processing is started. In step S51, processor 30 can search data server 102 for a search object image. After establishing data communication with data server 102, processor 30 can transmit the search object image to data server 102 and request data server 102 for an image search based on search object image data. In step S53, processor 30 can determine whether or not the search result has been obtained. Processor 30 determines whether or not the search result for the search object image has been received from data server 102. When data server 102 does not store information related to the search object image, and the search result has not been obtained from data server 102 (“NO” in step S53), processor 30 can proceed to the processing of step S57. When the search result has been obtained from data server 102 (“YES” in step S53), processor 30 can store the search result in step S55. Processor 30 stores the search result received from data server 102 in search result buffer 338.

In step S57, processor 30 can search flash memory 44 for a search object image. For example, processor 30 can search the database including a plurality of captured images and address book data stored in flash memory 44, for information related to the search object image. In step S59, processor 30 can determine whether or not the search result has been obtained. Processor 30 can determine whether or not information related to the search object image is stored in flash memory 44. When the information related to the search object image is not stored in flash memory 44 (“NO” in step S59), processor 30 can proceed to the processing of step S63. When the information related to the search object image is stored in flash memory 44 (“YES” in step S59), processor can store the search result in step S61. For example, when address information is obtained as a search result for the search object image, the address book information is stored in search result buffer 338.

In step S63, processor 30 can display the search result. Processor 30 displays search result pop-up P including contents stored in search result buffer 338 on display 14. When the search result is not stored in search result buffer 338, a character string such as “No search result has been obtained” is displayed in search result pop-up P to notify that no search result has been obtained. Processor 30 executing the processing of step S63 can serve as an output unit.

In step S65, processor 30 can determine whether or not there are a plurality of search results. It is determined whether or not a plurality of search results are stored in search result buffer 338. When it is “YES” in step S65, or when there are a plurality of search results (“YES” in step S65), processor 30 can determine in step S67 whether or not it is a switching operation. For example, it is determined whether or not the touch operation for switching the search result has been received. When the switching operation has not been performed (“NO” in step S67), processor 30 can proceed to the processing of step S71. When the switching operation has been performed (“YES” in step S67), processor 30 can switch display of the search result in step S69. In search result pop-up P, other search result is displayed. When the processing of step S69 is terminated, processor 30 can return to the processing of step S65. Processor 30 executing the processing of step S67 can serve as a third reception unit, and processor 30 executing the processing of step S69 can serve as a switching unit.

When there is one search result stored in search result buffer 338 (“NO” in step S65), processor 30 can determine whether or not it is terminated in step S71. It is determined whether or not an operation of terminating (erasing) display of search result pop-up P has been performed. When the operation of erasing display of search result pop-up P has not been performed (“NO” in step S71), processor 30 can return to the processing of step S65. When the operation of erasing display of search result pop-up P has been performed (“YES” in step S71), processor 30 can erase display of the search result in step S73. Display of search result pop-up P is erased. When the processing of step S73 is terminated, processor 30 can terminate the image search processing and return to the camera function processing.

### Second Embodiment

In the second embodiment, after the extraction region is set, image processing such as area selection based on color information and face detection processing is added, so that the search object image is extracted more suitably. Since mobile phone 10 of the second embodiment is substantially the same as that of the first embodiment, description as to the external appearance and the electric configuration will not be repeated.

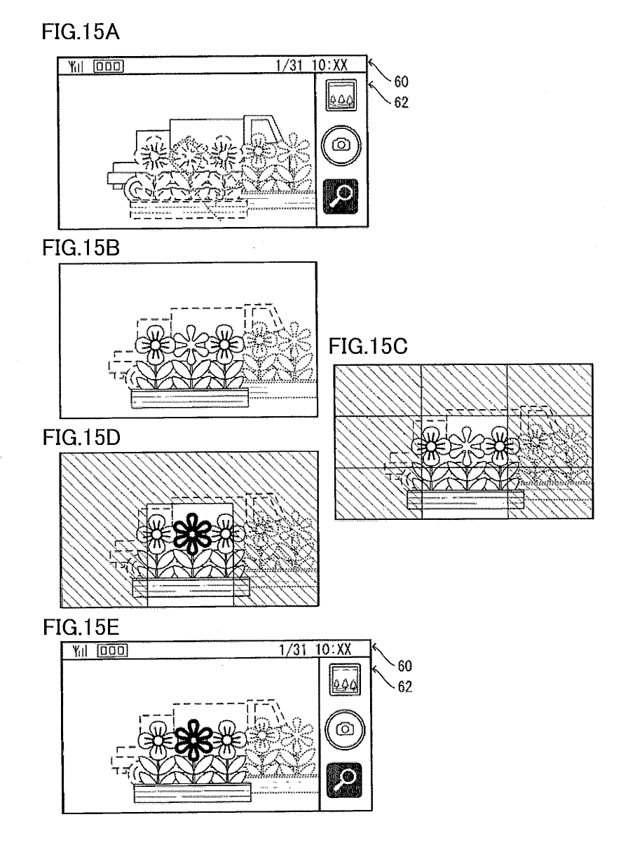

The processing of extracting a search object image using area selection based on color information will be described. Referring to FIGS. 15A to 15C, when the tap operation is performed at a position indicating any subject (such as a flower) in the search mode, the extraction region is set as with the first embodiment. Referring to FIG. 15D, when the extraction region is set, a region having color information which is substantially the same as color information at the touch position is selected. In the second embodiment, the search object image is extracted from the region selected in such a mariner For example, when a part of the “flower” is extracted as the search object image as shown in FIG. 15E, a color of the preview image other than the extracted portion (it is indicated by the thick line in the drawing) is set to be a gray scale.

When the shutter key is operated in such a state where the search object image is extracted, search result pop-up P displaying therein a search result for the search object image is displayed on display 14.

By utilizing the color information, a search object intended by a user can be more suitably extracted.

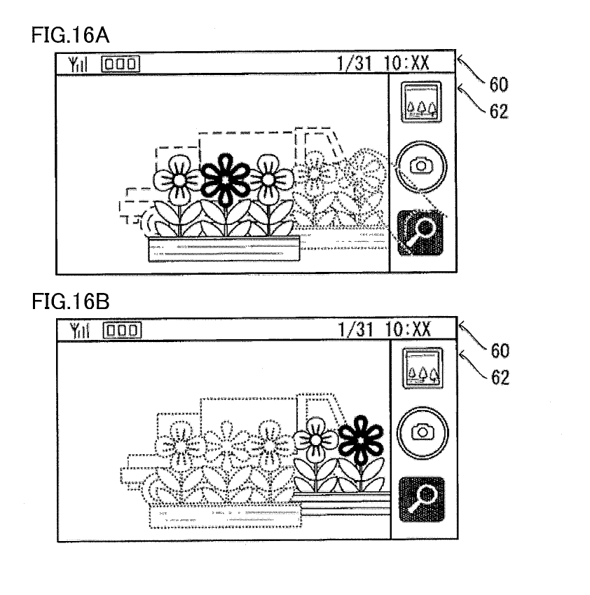

Referring to FIGS. 16A and 16B, in a state where a search object image is extracted, when the touch operation is performed at a position indicating other subject, the relative positional relationship is detected again, and the search object image is detected again. Substantially at the same time, the AF processing is performed such that a subject included in newly touched divided region R is brought into focus. For example, when the tap operation is performed on a flower in a flower bed on a rear side, the flower in the flower bed on the rear side is brought into focus, and a tapped part of the flower is extracted as a search object image.

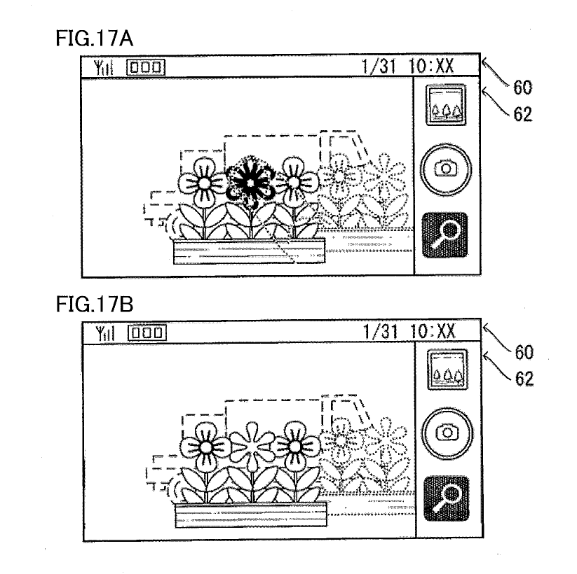

Referring to FIGS. 17A and 17B, when the tap operation is performed on a search object image, selection of the search object is cancelled, and a color of the preview image becomes non-gray scale. The camera screen returns to the state prior to the extraction of the search object. Even when a user selects a search object image by mistake, the selection can be cancelled. After the selection of the selection object image is cancelled, and when the same divided region R is touched, extraction conditions such as a threshold value for selection of a region by means of color information are changed, and the search object image is extracted.

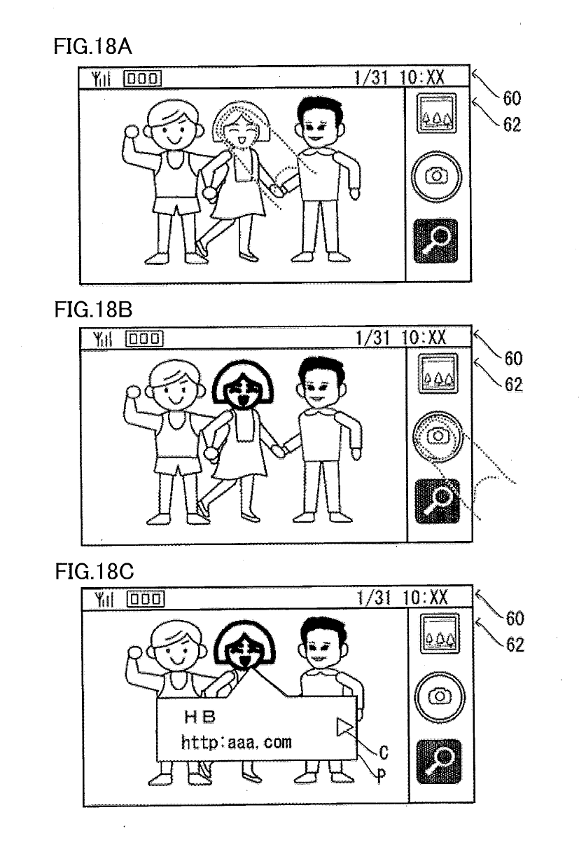

The process of extracting a search object image with use of face detection processing will be described. Referring to FIGS. 18A to 18C, when the tap operation is performed on the preview image, the extraction region is set as with the first embodiment. When the face detection processing is executed for the set extraction region, and a face is detected, the detected face is extracted as a search object image. When the shutter key is operated in the state where the search object image is extracted, the image search processing is executed, and search result pop-up P is displayed on display 14. By utilizing the face detection processing, a search object intended by a user can be more suitably extracted.

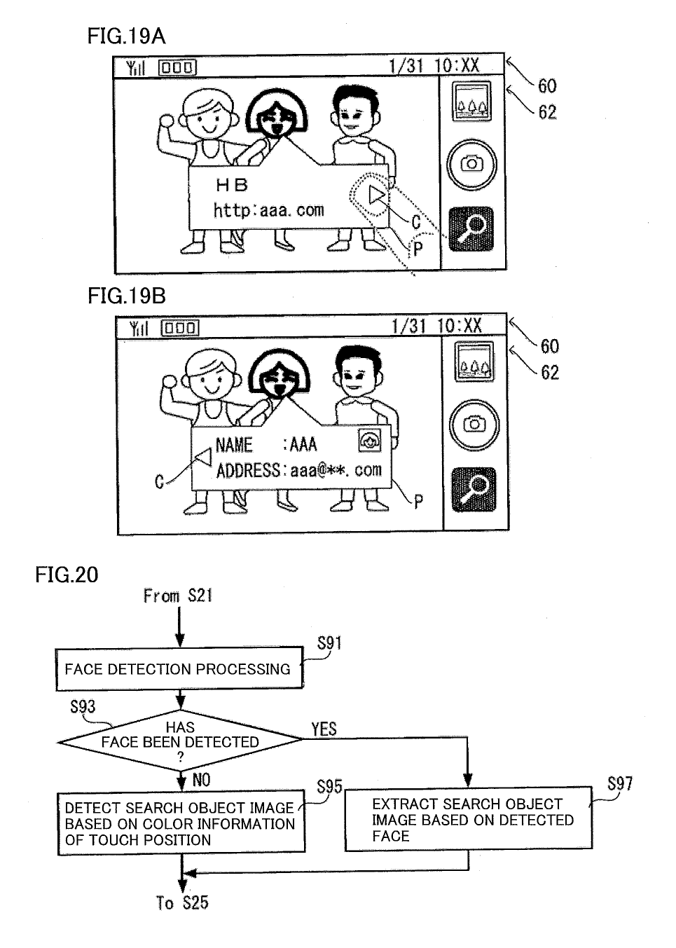

As shown in FIG. 18C, when a cursor C is included in search result pop-up P, it is indicated that plurality of search results are obtained. Referring to FIGS. 19A and 19B, when the tap operation is performed on cursor C, the search result displayed in search result pop-up P is switched. When a plurality of search results are obtained, a user can confirm the plurality of search results. When an original (previous) search result should be displayed, it would be all necessary to perform the tap operation on cursor C displayed on the left side. When three or more search results are obtained, cursor C for displaying the next search result is displayed on the right side in search result pop-up P.

The search result shown in FIG. 19A is obtained from data server 102. For example, when an image of a human face is extracted as a search object image, the database of data server 102 is searched for the face of the human. In this case, a URL (Uniform Resource Locator) of a page (HP: Homepage) of an SNS (Social Networking Service) to which a picture of the face of that human is sometimes obtained as a search result. In the search result shown in FIG. 19A, the name and URL of the page (HP) of the SNS is displayed as a search result. A user can perform an image search through the database stored in data server 102.

When the database of data server 102 is to be searched for information, search engine sites such as Yahoo! (registered trademark), Google (registered trademark), and the like may be used. When the search results are obtained through the search engine site, the search result indicated on top is displayed in search result pop-up P. When a search through a plurality of search engine sites is possible, it may be set such that the search can be performed through a search engine site which is compatible with a semantic search.

The search result shown in FIG. 19B is obtained from flash memory 44. For example, when address information associated with an image is present in the address book data stored in flash memory 44, that address information also becomes a search object. Here, when the face included in the search object image and the face included in the image associated with the address information are highly relevant, that address information is obtained as a search result. In the search result shown in FIG. 19B, the name, mail address, and registered image included in the address information are displayed as a search result. The image search can be performed through the database stored in flash memory 44 of mobile phone 10.

In the description above, features of the second embodiment are outlined. In the following paragraphs, the second embodiment will be described in detail with reference to the flowchart shown in FIG. 20.

FIG. 20 is a flowchart representing a part of the camera function processing of the second embodiment. Since the processing of steps Si to S21 and steps S25 to S31 are substantially the same in the camera function processing of the second embodiment, detailed description thereof will not be repeated.

When the camera function processing of the second embodiment is executed, processor 30 can execute the processing of steps S1 to S21. When the extraction region is set in the processing of step S21, processor 30 can execute the face detection processing in step S91. In order to determine whether or not a face is included in the extraction region, the face detection processing is executed for the extraction region. In step S93, processor 30 can determine whether or not a face has been detected. It is determined whether a face has been detected in the extraction region and whether a touch position is included in the detected face.

When a face has not been detected (“NO” in step S93), processor 30 can extract a search object image based on color information of the touch position in step S95. For example, when the tap operation has been performed as shown in FIG. 15A, a region is selected based on a color of the tapped flower. A search object image is extracted from the selected region. Even when the face has been detected, if a touch position is not included in that face, it is determined as “NO” in step S93.

When a face has been detected, and the touch operation has been performed on that face (“YES” in step S93), processor 30 detects a search object image based on the detected face. For example, when the tap operation has been performed on a face of a human as shown in FIG. 18A, that face is detected, thus the detected face is extracted as a search object image.

The search object image extracted in the processing of step S95 or step S97 is stored in search object image buffer 336. When the processing of step S95 or step S97 is terminated, processor 30 can proceed to the processing of step S25. Processor 30 executing the processing of step S95 or step S97 can serve as an extraction unit.

The image search can be performed by extracting a search object image from a captured image stored in flash memory 44. For example, when the browse function is executed, and a list of captured images stored in flash memory 44 is displayed in thumbnail view, and any captured image is selected, captured image data and corresponding metadata are read out. In this state, when the tap operation is performed on any subject in the captured image, the extraction region is set based on the relative positional relationship table included in the metadata, and the search object image is extracted. When the search object image is extracted, the image search is performed as described above, and the search result is displayed.

Lens 54 may be constituted of a plurality of zoom lenses and a plurality of focus lenses. In this case, by changing a lens position of the focus lenses, focus can be brought without changing focal length f. In such a case, a focus lens position in place of focal length f may be stored in the relative positional relationship table.

When a distance to a subject can be estimated or measured, the distance to the subject in place of focal length f described above may be stored in the relative positional relationship table.

Although not illustrated in the drawings, a plurality of search object images are extracted by performing a multi-touch operation on a plurality of subjects. In another embodiment, when a plurality of search object images are selected, a subject which is present between a subject on the most front side in the selected search object image and a subject on the most rear side may be extracted as a search object image. In another embodiment, all of a plurality of extraction regions included in the range of focal length determined based on a plurality of extraction region are selected. For example, when an image of a subject having a depth is captured, and a front side portion of the subject is tapped, only the front side portion of the subject is extracted as a search object image. When the multi-touch operation is performed at two locations, including the front side portion and the rear side portion, the entire subject can be collectively extracted as a search object image. In another example, the operation performed by a user to extract a search object image is simplified.

When the slide operation of surrounding any region is performed rather than the tap operation, a search object image may be extracted from the optional region.

The database stored in flash memory 44 may include data other than address book data and captured images.

In another embodiment, when the shutter key is operated without extracting the search object image, the entire preview image may be extracted as a search object image, and the image search processing may be executed.

In yet another embodiment, when mobile phone 10 can display a TV (Television) broadcast, any scene can be captured, and an image search may be performed by extracting a search object image from the captured image.

In embodiments, a search result is displayed on display 14. However, in yet another embodiment, it may be output from speaker 18 by means of sound, or it may be transferred to another terminal or PC and output from the other terminal or PC (it may include displaying).

The programs used in embodiments may be stored in an HDD (Hard Disk Drive) of a data distribution server and distributed to mobile phone 10 via a network. In a state where a plurality of programs are stored storage media such as optical disks like CD (Compact Disc), DVD (Digital Versatile Disc), BD (Blu-Ray Disk), a USB (Universal Serial Bus) memory, a memory card, and the like, the storage media may be sold or distributed. When a program downloaded through the above-described server, storage media, or the like is installed in a mobile phone having a configuration equivalent to those of embodiments, the effect equivalent to those of embodiments can be obtained.

The specific values shown in the present specification are merely examples, and these values can be appropriately changed in accordance with a change in specification of a product.

The present disclosure employs the following configurations. The reference characters and supplemental description in the parentheses indicate correspondence with the embodiments described to support understanding of the present disclosure, and do not limit the present disclosure at all.

A first aspect of the disclosure is a mobile terminal having a camera unit, a display unit and at least one processor. The processor is configured to detect a relative positional relationship between subjects from an image obtained from the camera unit. The processor is configured to extract an object image from the image based on the relative positional relationship. The processor is configured to search for predetermined information based on the object image. The processor is configured to output a search result.

According to the first aspect of the disclosure, in the mobile terminal (10: a reference character illustrating a corresponding part in embodiments, and this similarly applies in the following paragraphs), the camera unit (50-54) can output an image. For example, the image is obtained, and a preview image based on the obtained image is displayed on the display unit (14). For example, when a user performs an operation of selecting a subject, the processor (30, S19) can detect a relative positional relationship between subjects from the image obtained from the camera unit. The processor (30, S23, S95, S97) can extract an object image from the obtained image based on the detected relative positional relationship so that, for example, a subject selected by a user is included. For example, based on the object image, the processor (30, S31) can search for predetermined information related to the object image. The processor (30, S63) outputs the search result to, for example, the display unit, and the search result is displayed on the display unit.

According to first aspect of the disclosure, by utilizing the relative positional relationship between subjects, the object image can be suitably extracted, so that the search accuracy of the image search can be improved.

A second aspect of the disclosure is dependent on the first aspect. The processor is configured to receive an extraction operation of extracting an object image when the image obtained from the camera unit is displayed, and to detect the relative positional relationship.

In the second aspect of the disclosure, for example when an operation of selecting a subject is performed on a preview image, the processor (30, S13) can receive the operation as the extraction operation. When the extraction operation is received, the processor can detect a relative positional relationship between subjects.

According to the second aspect of the disclosure, a user can perform an image search for a subject of interest during image capturing.

A third aspect of the disclosure is dependent on the second aspect, and further includes a touch panel. The processor is configured to receive a touch operation on the touch panel as an extraction operation. The processor is configured to extract an object image from an image based on the touch operation.

In the third aspect of the disclosure, for example, a touch panel (16) for detecting the touch operation is located on the display unit. For example, the processor can receive the touch operation on the preview image as the extraction operation. When the touch operation is performed on the preview image, the object image is extracted.

According to the third aspect of the disclosure, a user can readily perform an image search by specifying a search object with an intuitive operation on the touch panel.

A fourth aspect of the disclosure is dependent on the first aspect. The processor is configured to set an extraction region in an image obtained from the camera unit based on the relative positional relationship, and to extract an object image from the image based on the extraction region.

In the fourth aspect of the disclosure, for example, the preview image is divided into a plurality of divided regions (R), and when any divided region is specified by a user, the processor (30, S21) can set the specified divided region and a divided region including a subject which is present at the same position (distance) as the subject included in the divided region as an extraction region. For example, the processor can extract an image within the extraction region as an object image.

According to the fourth aspect of the disclosure, by setting the extraction region, a user can identify an object image to be extracted.

A fifth aspect of the disclosure is dependent on the first aspect, and the camera unit includes a lens. The processor is configured to detect a relative positional relationship between subjects from the image obtained from the camera unit by utilizing a focal length of the lens.

In the fifth aspect of the disclosure, the camera unit includes lens (54). For example, utilizing a focal length of the lens when moving the lens from a tele end to a wide end, the processor can detect the relative positional relationship between subjects.

According to the fifth aspect of the disclosure, since the relative positional relationship can be detected with use of the focal length of the lens, the relative positional relationship between the subjects can be detected even with an existing mobile terminal including a camera unit by updating or adding software.

A sixth aspect of the disclosure is dependent on the first aspect. The processor is configured to receive a changing operation of changing an object image. The processor is configured to detect the relative positional relationship again when a changing operation is received, and to extract another object image from the image obtained from the camera unit based on the changing operation and the relative positional relationship detected again.

In the sixth aspect of the disclosure, the processor (30, S25) can receive, for example, the operation of specifying another search object as the changing operation. When the changing operation is performed, the relative positional relationship between the subjects is detected again. The processor can extract another object image from the obtained image based on the relative positional relationship detected again.

According to the sixth aspect of the disclosure, a user can optionally change a search object even when he/she selects the search object by mistake.

A seventh aspect of the disclosure is dependent on the first aspect. The processor is configured to, when there are a plurality of search results, receive a switching operation of switching output search results. The processor is configured to switch the output search results when the switching operation is received.

In the seventh aspect of the disclosure, when a plurality of search results are output, the processor (30, S67) can receive the switching operation of switching output search results. The processor (30, S69) can switch the output search results when the switching operation is received.

According to the seventh aspect of the disclosure, when a plurality of search results are obtained, a user can confirm each of the plurality of search results.

An eighth aspect of the disclosure is dependent on the first aspect. The processor is configured to extract an object image based on color information.

In the eighth aspect of the disclosure, for example, when the touch operation of specifying a search object is performed, a range of color which is substantially the same as color information at a touch position is selected. The processor can extract the object image from that region.

According to the eighth aspect of the disclosure, by utilizing the color information, a search object intended by a user can be extracted more suitably.

A ninth aspect of the disclosure is dependent on the first aspect. The processor can extract an object image by utilizing face detection.

In the ninth aspect of the disclosure, for example, face detection processing is executed for a preview image in proximity to the touched position, and when a face is detected, an image of the detected face is extracted as an object image.

According to the ninth aspect of the disclosure, by utilizing the face detection processing, a search object intended by a user can be more suitably detected.

A tenth aspect of the disclosure is dependent on the first aspect. The processor is configured to output a search result for the object image from a database stored in a server on a network.

In the tenth aspect of the disclosure, a search result for an object image is output from the database stored in the server (102) on the network.

According to the tenth aspect of the disclosure, a user can perform an image search through the database stored in the server.

An eleventh aspect of the disclosure is dependent on the first aspect, and further includes a storage unit configured to store the database. The processor is configured to output a search result for the object image from a database stored in the storage unit.

In the eleventh aspect of the disclosure, a search result for an object image is output from the database stored in the storage unit (44).

According to the eleventh aspect of the disclosure, an image search can be performed through the database stored in the storage unit of the mobile terminal.

A twelfth aspect of the disclosure is a method for searching for an image in a mobile terminal (10) having a camera unit (50-54), a display unit (14) and at least one processor (30). The method for searching for an image includes detecting (S19), extracting (S23, S95, S97), searching (S31), and outputting (S63). In the detecting, the processor (30) of the mobile terminal detects a relative positional relationship between subjects from an image obtained from the camera unit. In the extracting, an object image is extracted from the image based on the relative positional relationship. In the searching, predetermined information is searched for based on the object image. In the outputting, the search result obtained by the searching step is output.

Also in the twelfth aspect of the disclosure, as with the first aspect, an object image can be suitably extracted by utilizing the relative positional relationship between subjects, so that the search accuracy of the image search can be improved.

Although the present disclosure has been described and illustrated in detail, it is clearly understood that the same is by way of illustration and example only and is not to be taken by way of limitation, the scope of the present disclosure being interpreted by the terms of the appended claims.

1. A mobile terminal comprising:
a camera unit;
a display unit; and
at least one processor,
the processor being configured to
detect a relative positional relationship between subjects from an image obtained from the camera unit,
extract an object image from the image based on the relative positional relationship,
search for predetermined information based on the object image, and
output a search result.

2. The mobile terminal according to claim 1, wherein the processor is configured to
receive an extraction operation of extracting an object image when the image obtained from the camera unit is displayed, and
detect the relative positional relationship.

3. The mobile terminal according to claim 2, further comprising a touch panel, wherein the processor is configured to
receive a touch operation on the touch panel as an extraction operation, and
extract an object image from an image based on the touch operation.

4. The mobile terminal according to claim 1, wherein the processor is configured to
set an extraction region in an image obtained from the camera unit based on the relative positional relationship, and
extract an object image from the image based on the extraction region.

5. The mobile terminal according to claim 1, wherein
the camera unit includes a lens, and
the processor is configured to detect a relative positional relationship between subjects from the image obtained from the camera unit by utilizing a focal length of the lens.

6. The mobile terminal according to claim 1, wherein the processor is configured to
receive a changing operation of changing an object image,
detect the relative positional relationship again when a changing operation is received, and
extract another object image from the image obtained from the camera unit based on the changing operation and the relative positional relationship detected again.

7. The mobile terminal according to claim 1, wherein the processor is configured to
when there are a plurality of search results, receive a switching operation of switching output search results, and
switch output search results when the switching operation is received.

8. The mobile terminal according to claim 1, wherein the processor is configured to extract an object image based on color information.

9. The mobile terminal according to claim 1, wherein the processor is configured to extract an object image by utilizing face detection.

10. The mobile terminal according to claim 1, wherein the processor is configured to output a search result for the object image from a database stored in a server on a network.

11. The mobile terminal according to claim 1, further comprising a storage unit for storing a database, wherein
the processor is configured to output a search result for the object image from a database stored in the storage unit.

12. A method for searching for an image in a mobile terminal having a camera unit, a display unit and at least one processor, the method including:
detecting a relative positional relationship between subjects from an image obtained from the camera unit;
extracting an object image from the image based on the relative positional relationship;
searching for predetermined information based on the object image; and
outputting a search result obtained by the searching.
